(19) United States
(12) Patent Application Publication
(10) Pub. No.: US 2012/0174798 A1
(43) Pub. Date: Jul. 12, 2012

(54) COOK POT WITH PIVOTING COLANDER

(76) Inventor: Frank Kulikowski, Batavia, NY (US)

(21) Appl. No.: 13/004,736

(22) Filed: Jan. 11, 2011

(51) Int. Cl. A47J 37/07

(52) U.S. Cl. 99/340

(57) ABSTRACT

Provided is a pivoting cooking pot comprising an outer pot having an upper rim topping pot side walls and defining an inner region for bounding a colander wherein the side walls contain no holes; the colander comprising curved colander walls and a top colander rim; opposing pivot means for pivotally engaging and suspending the colander within the side walls of the pot during use; the opposing pivot means, further comprising: axel members projecting coaxially from opposing inner portions of the pot side walls proximate the upper pot rim; and means for releasably and rotatably engaging respective axel members projecting from outer portions of the colander walls proximate the axel members, wherein the means for releasably and rotatably engaging enabling a pivoting about the respective axel members during use, whereby when pot is tilted relative to an external plane the colander retains a respective position relative to the external plane.

### BACKGROUND OF THE INVENTION

1. Field of the Invention

The present disclosure relates to a cooking pot having an integrated and removable strainer or colander member. More specifically, the present disclosure relates to a cooking pot having a lockably pivoting and removable colander member.

2. Description of the Related Art

There are a number of cooking systems having a pot with an integrated strainer or colander member. U.S. Pat. No. 6,546,849 to Shimazaki discloses cooking system wherein an inner colander or steamer is shaped to allow an interference fit between the outer diameter side wall of the colander and the inner side wall of an outer pot. Interfering profiles on the outer edge of the colander permit the colander to be used for holding food, as well as to be inverted to function as a lid.

U.S. Pat. No. 4,626,352 to Massey describes a pot lid with an unusually shaped depending straining skirt portion which has a terminal edge wall profile engageable with the outer pot. A protruding lip of the pot lid engages a receiving ridge profile projecting from the top edge of the outer pot and allows the pot lid to sit at an angle to the top plane of the outer pot. During co-rotation, an interference engagement with the outer pot side wall such that the lid and pot side wall are leveraged together and held in place in a partially open position such that the entire assembly is tilted for straining. As described, the design does not provide a removable colander or strainer.

Patent WO 2008/036785 describes a cooking pot system having a pivoting colander suspended within the pot. During use, the colander, containing food product, is suspended in boiling water such that the food product is cooked. After cooking the food, the pot is tilted to remove the water. The colander pivots so that the food product is not accidentally dumped from the pot. A pin passes through a hole in the pot and engages the colander, thereby preventing the colander from pivoting when not desired. This system suffers some significant drawbacks. First, the hole in the pot allows boiling water to escape the pot and run down the outside of the pot onto the stove top. This overflow can cause gas burners to flare up leading to the risk of burning the user or starting a fire. Second, a user may contact the hot water escaping the pot thereby suffering burns.

Thus, it can be seen that there is a long felt need for a cooking system wherein the user can lift the pot and colander at the same time, and empty the contents of the pot without first needing to remove the colander where water used in cooking is contained within the pot during boiling. Accordingly, there is a need for an improved hinge for mounting the pivoting colander within the pot such that steam and boiling water does not escape the pot and run down the outside of the pot during use.

### OBJECTS AND SUMMARY OF THE INVENTION

The present disclosure provides a cooking pot system responding to at least one of the needs noted above.

Another aspect of the present disclosure provides an integrated cooking pot and removable strainer or colander member having a removable handle.

Another aspect of the present disclosure is to provision of a cooking system, wherein a cooking colander may be used following cooking to suspend cooked food within the original cooking pot off of the cooking surface thereby preventing continued cooking of the food and subsequent burning.

The present invention relates to a cooking system having an outer cooking pot member having outer side walls possessing no holes. An inner pivoting member pivotally and removably engages hinge members on the inner surface of the cooking pot side walls and is suspended therebetween. A lid allows for retention of temperature and steam. In one aspect of the present embodiment a set of journals project from the suspended inner pivoting member and engage slidable axel members projecting from the inner side walls of the outer pot member.

According to one aspect of the present disclosure, there is provided a pivoting cooking pot system, comprising: an outer cooking pot member having an upper pot rim topping extending pot side walls and defining an inner region within for bounding an inner colander member during an assembly therewith, wherein the extending pot side walls contain no through-holes between an outside atmosphere and the inner region; the inner colander member comprising curved colander side walls and a top colander rim member opposite a bottom portion; first and second opposing pivot means for pivotally engaging and suspending the inner colander member within the extending pot side walls of the cooking pot member during a use; the first and second opposing pivot means, further comprising: axel members projecting coaxially from opposing inner portions of the pot side walls proximate the upper pot rim; and means for releasably and rotatably engaging respective the axel members; and the means for releasably and rotatably engaging projecting from outer portions of the colander side walls proximate respective the coaxial axel members, wherein the means for releasably and rotatably engaging enabling a pivoting about the respective axel members during the use following the assembly, whereby when outer cooking pot member is tilted relative to an external reference plane the inner colander member retains a respective position relative to the external reference plane.

According to another aspect of the present disclosure, there is provided a pivoting cooking pot system, wherein: the means for releasably and rotatably engaging includes projecting pivot flange members projecting from the outer portions of the colander side walls; each the projecting pivot flange member including a receiving slot having opposing slot side walls shaped to receive the respective axel member; each the receiving slot being longer than a support dimension of each the axel member, whereby the axel member slides within the receiving slot during the assembly and rotates during the use thereby pivoting reliably.

According to another aspect of the present disclosure, there is provided a pivoting cooking pot system, wherein: the projecting pivot flange members further comprise tapered guiding walls on the receiving slot side walls; a distance between the slot side walls being less than a distance between the tapered guiding walls, whereby the tapered guiding walls guiding the axel members from the tapered guiding walls to the receiving slot side walls during the assembly into a secure rotation engagement with the means for releasably and rotatably engaging.

According to another aspect of the present disclosure, there is provided a pivoting cooking pot system, further comprising: suspending leg portions projecting from opposing sides of the projecting pivot flange members for spacing engaging surfaces of the projecting pivot flange members from the outer portions of the colander side walls; and the engaging surfaces oriented substantially perpendicular to a rotation axis of the respective axel members, whereby the releasing and pivoting engagement between the outer cooking pot member and the inner colander member enables a smooth rotation therebetween.

According to another aspect of the present disclosure, there is provided a pivoting cooking pot system, further comprising: a carry handle pivotably extending from portions of one of the colander rim member and the colander side walls enabling a ready manipulation of the colander member during the assembly and use.

According to another aspect of the present disclosure, there is provided a pivoting cooking pot system, according to claim 1, further comprising: at least two pot carry handles extending outwardly from the outer cooking pot member; and the two pot carry handles proximate the upper pot rim on outer portions of the extending pot side walls, whereby the at least two pot carry handles enable a ready manipulation of the pivoting cooking pot system during the use.

According to another aspect of the present disclosure, there is provided a pivoting cooking pot system, according to claim 1, further comprising: locking means for releasably restraining the rotation of the inner colander member relative to the outer cooking pot member during the use.

The above and other objects, features and advantages of the present disclosure will become apparent from the following description read in connection with the accompanying drawings.

### BRIEF DESCRIPTION OF THE DRAWINGS

FIG. 1 is an exploded perspective view of a cooking system having an outer pot and an inner strainer or colander with improved hinge.

FIG. 2 is a close up exploded view of the hinge construction of the embodiment in FIG. 1.

FIG. 3 is a side elevational view of the first hinge construction of FIG. 2.

FIG. 4 is a partially removed side elevational view of the embodiment of FIG. 1 in a pour-to-strain arrangement.

FIG. 5 is a partially removed side elevational view wherein the strainer or colander is removed from the outer pot and the water enters the outer pot.

### DETAILED DESCRIPTION OF THE PREFERRED EMBODIMENTS

Reference will now be made in detail to several embodiments of the disclosure that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the disclosure in any manner. The words “connect,” “couple,” and similar terms with their inflectional morphemes do not necessarily denote direct and immediate connections, but also include connections through mediate elements or devices.

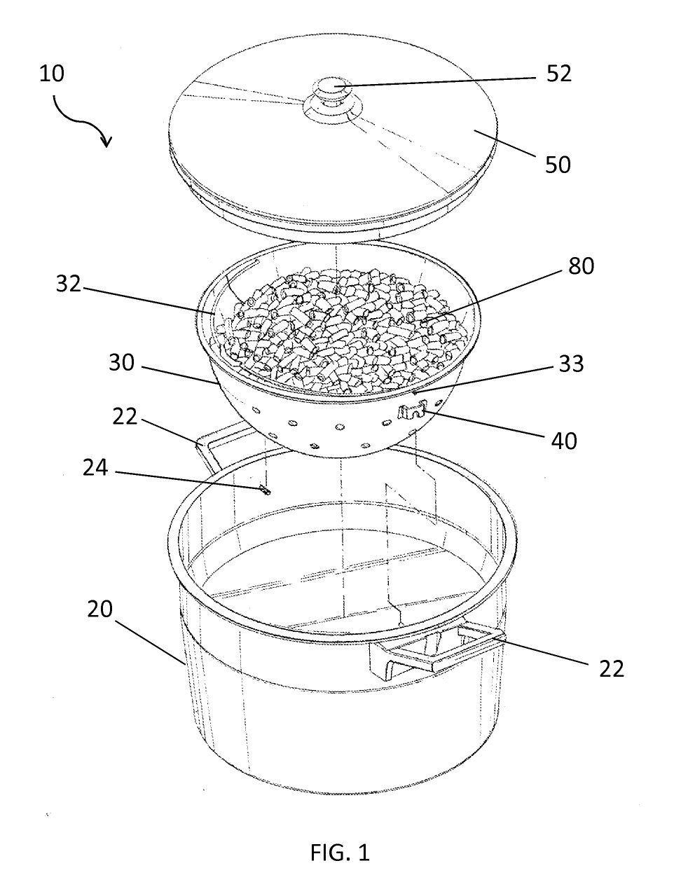

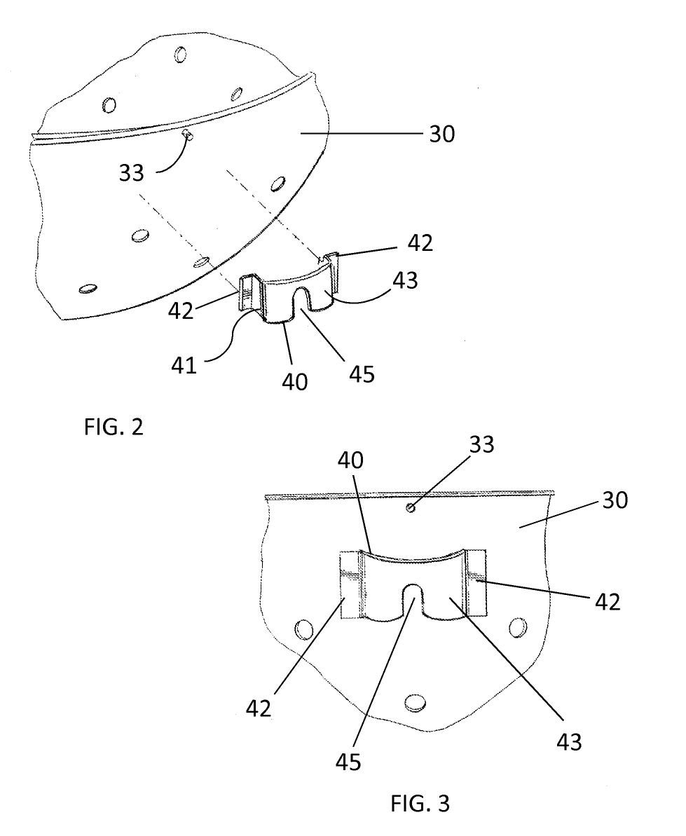

Referring not to FIGS. 1 through 5, a cook pot with pivoting colander system 10 is provided with an outer pot member 20, suspending an inner colander member 30 having a supporting handle 32. Handle 32 can be constructed of any suitable material, but is preferably formed of wire and is more preferably wire coated with a heat resistant material such as silicone. Handle 32 is pivotably engaged through a pivor hole proximate the upper side lip of colander member 30 and ends 33 thereof project through proximate a pair of opposing pivot members 40, 40, as will be discussed. A lid 50 having a lid handle 52 is formed with a depending lip (shown but not numbered) to engage the top lip region of outer pot member 20 forming a close fit.

Pivot members 40, 40 are fixed to opposite sides of colander member 30 as shown at positions below the respective location of the depending lip of lid 50 during assembly of system 10 so as to not interfere with lid operations. Pivot members 40, 40 are formed of any suitable material, and more preferably formed from bent metal pieces having bent leg potions 41 and flanges 42 for contacting the curved side walls of colander member 30 while maintaining the outer face 43 of pivot members 40, 40 in a vertical condition when assembled and in use. A hinge slot 45 is positioned in each pivot member 40, 40 and has an upper profile that matches the profile of respective projecting axel stud members 24, 24, allowing smooth rotation following assembly. Importantly, axel stub members 24, 24 project inwardly from the inner surface of pot member 20 and do not create any holes within the surface of pot member 20. Pot member 20 has no holes or perforations within its side walls thereby preventing boiling water and steam from escaping via the sides of the pot. Thus, users are protected from potential flare ups and skin burns due to boil-overs and steam release.

To ease assembly during repeated use, hinge slots 45, 45, include tapered side walls functioning as guide walls to guide respective axel studs 24 into hinge slots 45 for ease of use. Thus during a re-assembly, a user suspending colander member 30 via colander handle member 32 positions colander 30 within pot member 20 proximate axel stud members 24 and lowers colander 30 so that axel stud members 24 first encounter tapered walls and are guided onto hinge slots 45.

As shown, colander 30 includes food product 80, while pot member 20 is filled with water 90 for cooking, for example by boiling or steaming. A plurality of hole passages on colander 30 allow water or steam access to food 80. Handles 22, 22 project outwardly from outer portions of the upper side walls of outer pot member 20 as shown and are positioned proximate the locations of pivot members 40, 40.

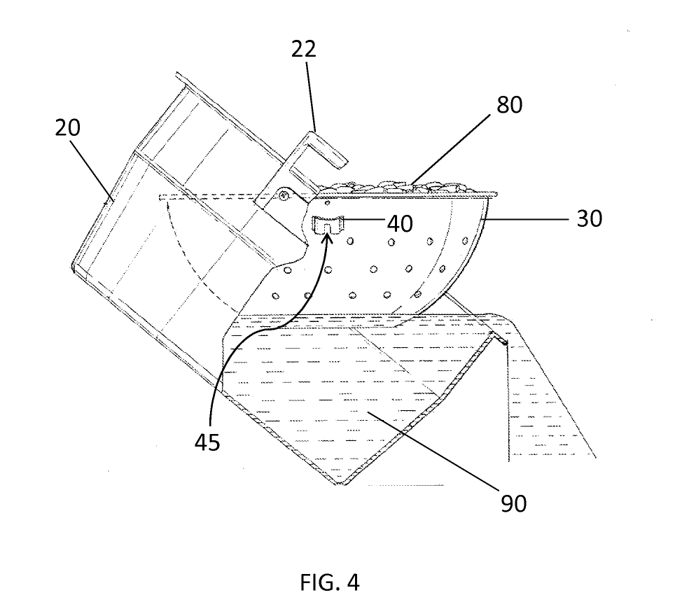

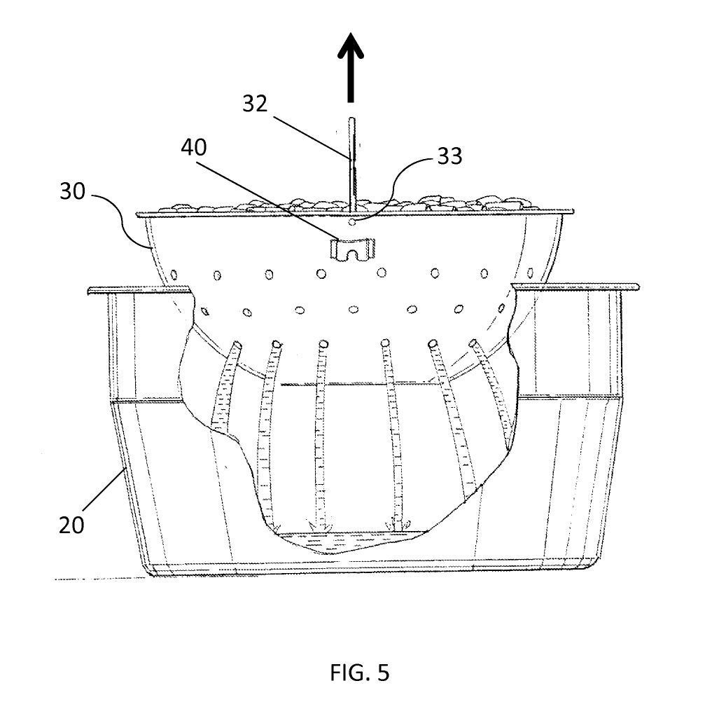

It will be recognized from FIG. 4, specifically, that during us a user may grip respective handle members 22, 22 and tilt outer pot member 20 for pouring off water 90. Simultaneously, as outer pot member 20 rotates relative to the horizontal position (pre-tilt), inner colander member 30 also rotates about axel stud members 24 retained in hinge slots 45 of pivot members 40 and maintains the original pre tilt horizontal position, thereby preventing food 80 from falling out of colander member 30. Simultaneously, water 90 drains from colander member 30 into pot 20 throughout the pouring-emptying process until all water 90 is removed from the pot 20. Thereafter, a user may simply lift handle 32 and remove colander member 30 containing the now-drained and cooked food 80 for convenient serving.

Although the invention has been described with reference to certain preferred embodiments, it will be appreciated by those skilled in the art that modifications and variations may be made without departing from the spirit and scope of the invention. It should be understood that applicant does not intend to be limited to the particular details described above and illustrated in the accompanying drawings.

What is claimed is:

1. A pivoting cooking pot system, comprising:
an outer cooking pot member having an upper pot rim topping extending pot side walls and defining an inner region within for bounding an inner colander member during an assembly therewith, wherein said extending pot side walls contain no through-holes between an outside atmosphere and said inner region;
said inner colander member comprising curved colander side walls and a top colander rim member opposite a bottom portion;
first and second opposing pivot means for pivotally engaging and suspending said inner colander member within said extending pot side walls of said cooking pot member during a use;
said first and second opposing pivot means, further comprising:
axel members projecting coaxially from opposing inner portions of said pot side walls proximate said upper pot rim; and
means for releasably and rotatably engaging respective said axel members; and
said means for releasably and rotatably engaging projecting from outer portions of said colander side walls proximate respective said coaxial axel members, wherein said means for releasably and rotatably engaging enabling a pivoting about said respective axel members during said use following said assembly, whereby when outer cooking pot member is tilted relative to an external reference plane said inner colander member retains a respective position relative to said external reference plane.

2. A pivoting cooking pot system, according to claim 1, wherein:
said means for releasably and rotatably engaging includes projecting pivot flange members projecting from said outer portions of said colander side walls;
each said projecting pivot flange member including a receiving slot having opposing slot side walls shaped to receive said respective axel member;
each said receiving slot being longer than a support dimension of each said axel member, whereby said axel member slides within said receiving slot during said assembly and rotates during said use thereby pivoting reliably.

3. A pivoting cooking pot system, according to claim 2, wherein: said projecting pivot flange members further comprise tapered guiding walls on said receiving slot side walls;
a distance between said slot side walls being less than a distance between said tapered guiding walls, whereby said tapered guiding walls guiding said axel members from said tapered guiding walls to said receiving slot side walls during said assembly into a secure rotation engagement with said means for releasably and rotatably engaging.

4. A pivoting cooking pot system, according to claim 3, further comprising:
suspending leg portions projecting from opposing sides of said projecting pivot flange members for spacing engaging surfaces of said projecting pivot flange members from said outer portions of said colander side walls; and
said engaging surfaces oriented substantially perpendicular to a rotation axis of said respective axel members, whereby said releasing and pivoting engagement between said outer cooking pot member and said inner colander member enables a smooth rotation therebetween.

5. A pivoting cooking pot system, according to claim 1, further comprising:
a carry handle pivotably extending from portions of one of said colander rim member and said colander side walls enabling a ready manipulation of said colander member during said assembly and use.

6. A pivoting cooking pot system, according to claim 1, further comprising:
at least two pot carry handles extending outwardly from said outer cooking pot member; and
said two pot carry handles proximate said upper pot rim on outer portions of said extending pot side walls, whereby said at least two pot carry handles enable a ready manipulation of said pivoting cooking pot system during said use.

7. A pivoting cooking pot system, according to claim 1, further comprising:
locking means for releasably restraining said rotation of said inner colander member relative to said outer cooking pot member during said use.
